(19) United States
(12) Patent Application Publication
(10) Pub. No.: US 2014/0174229 A1
(43) Pub. Date: Jun. 26, 2014

(54) AUTOMATIC MULTI-SPEED GEAR SYSTEM

(71) Applicant: Samir Moufawad, Mazraat Yashouh (LB)

(72) Inventor: Samir Moufawad, Mazraat Yashouh (LB)

(21) Appl. No.: 14/184,507

(22) Filed: Feb. 19, 2014

Related U.S. Application Data
(63) Continuation-in-part of application No. 13/038,383, filed on Mar. 1, 2011, now Pat. No. 8,720,291.
(60) Provisional application No. 61/344,442, filed on Jul. 23, 2010.

(51) Int. Cl. F16H 3/02

(52) U.S. Cl. CPC F16H 3/02
USPC 74/331

(57) ABSTRACT

An automatic multi-speed gear system includes an input axle, a first arm coupled at one end with the input axle through bearings that allow for independent rotational movement of the input axle along its longitudinal axis. The first arm is also configured to rotate about the input axle as its pivot. The system also includes a first axle coupled with bearings at the opposing end of the first arm. A first set of gears coupled to the input axle and the first axle transfer the rotational motion of the input axle to the first axle. The system also includes a second arm coupled at one end with bearings to the first axle and at the opposing end to a second axle. The second axle is coupled through a one way bearing to an output axle. A second set of gears coupled to the first axle and the second axle transfer the rotational motion of the first axle to the second axle and a third set of gears coupled to the second axle and the output axle transfer the rotational motion of the second axle to the output axle. The one-way bearing facilitates operation in either a low speed configuration or a high speed configuration.

### CROSS-REFERENCE TO RELATED APPLICATIONS

This application is a continuation-in-part of U.S. patent application Ser. No. 13/038,383, filed on Mar. 1, 2011, which claims the benefit of U.S. Provisional Patent Application No. 61/344,442, filed on Jul. 23, 2010, specifications of which are herein incorporated by reference in their entirety.

### BACKGROUND OF THE INVENTION

1. Field of the Invention

Embodiments of the invention described herein pertain to the field of gearing. More particularly, but not by way of limitation, one or more embodiments of the invention enable an automatic multi-speed gear system.

2. Description of the Related Art

Multi-speed gear systems are widely used in mechanical systems. Multi-speed gear systems improve the function and usefulness of mechanical systems by giving the system the ability to vary important output parameters. The multi-speed gear system is typically coupled with an input power source, including mechanical power sources, electrical power sources, and mixed power sources. Typically, a high gear ratio decreases speed and increases torque, while a low gear ratio increases speed but decreases torque. In a manual multi-speed gear system, a user must manually switch gears to vary parameters for suitability to operating conditions.

Automatic multi-gear systems are configured to make a gear selection without user input. Ideally, when more torque is required, a low-speed gear should be selected. Automatic multi-gear systems typically involve complex hydraulic systems and/or electronic control systems. For example, a hydraulic automatic transmission typically requires a fluid coupling or torque converter.

To overcome the problems and limitations described above there is a need for a simple automatic multi-speed gear system.

### BRIEF SUMMARY OF THE INVENTION

One or more embodiments of the invention enable an automatic multi-speed gear system. Automatic multi-speed functionality is based on a high-speed misalignment position to a low-speed alignment position.

No hydraulics or electronic controls are necessary to control one or more embodiments of the automatic multi-speed gear system. However, one or more embodiments of the automatic multi-speed gear system described herein are compatible with hydraulics and/or electronic control systems. One or more embodiments of the automatic multi-speed gear system can be used in any application for multi-speed gearing, such as bicycles, motorized vehicles, RC vehicles, motorized toys, or any other application compatible with an automatic multi-speed gear system.

One or more embodiments of the automatic multi-speed gear system are directed to multi-speed gear systems including two or more cascaded two-speed gear systems. For example, a three-speed gear system can be configured by cascading two two-speed gear systems, a four-speed gear system can be configured by cascading three two-speed gear systems, a five-speed gear system can be configured by cascading four two-speed gear systems, etc.

One or more embodiments of the automatic multi-speed gear system are directed to multi-speed gear systems including two or more cascaded two-speed gear systems with mechanical control of arm alignment of each two-speed gear system. In one or more embodiments implementing mechanical control of arm alignment for each two-speed gear system, a four-speed gear system can be configured by cascading two two-speed gear systems, an eight-speed gear system can be configured by cascading three two-speed gear systems, a sixteen-speed gear system can be configured by cascading four two-speed gear systems, etc.

One or more embodiments of the automatic multi-speed gear system are directed to an automatic multi-speed gear system including at least one gear system. The basic unit of the multi-speed gear system is the two-speed gear system.

The two-speed gear system includes an input axle configured to couple with a power source. When coupled, the power source rotates the input axle along its longitudinal axis.

In one or more embodiments, the two-speed gear system includes a first arm coupled at one end with the input axle through bearings that allow for independent rotational movement of the input axle along its longitudinal axis. The first arm is also configured to rotate about the input axle as its pivot.

In one or more embodiments, the two-speed gear system further includes a first axle coupled with bearings at the opposing end of the first arm. The first axle is configured for independent rotation about its longitudinal axis. A first set of gears coupled to the input axle and the first axle transfer the rotational motion of the input axle to the first axle.

In one or more embodiments, the two-speed gear system further includes a second arm coupled at one end with bearings to the first axle and at the opposing end to a second axle. The second axle is configured for independent rotation about its longitudinal axis. A second set of gears coupled to the first axle and the second axle transfer the rotational motion of the first axle to the second axle.

The second axle is coupled through a one-way bearing to an output axle via a third set of gears. In a preferred embodiment, the output axle's longitudinal axis is the center of the one-way bearing. The third set of gears transfer the rotational motion of the second axle to the output axle. The one-way bearing facilitates operation in either a low speed configuration or a high speed configuration.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of the side cross-sectional view of an exemplary two-speed gear system in accordance with one or more embodiments of the present invention.

FIG. 2 is an illustration of the two-speed gear system in a high-speed operation in accordance with one or more embodiments of the present invention.

FIG. 3 is an illustration of the two-speed gear system in a transition from high speed to low-speed operation in accordance with one or more embodiments of the present invention.

FIG. 4 is an illustration of the motion the two-speed gear system in a low-speed configuration in accordance with one or more embodiments of the present invention.

FIG. 5 is an illustration of a cascaded multi-speed gear system in accordance with one or more embodiments of the present invention.

### DETAILED DESCRIPTION

An automatic multi-speed gear system will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

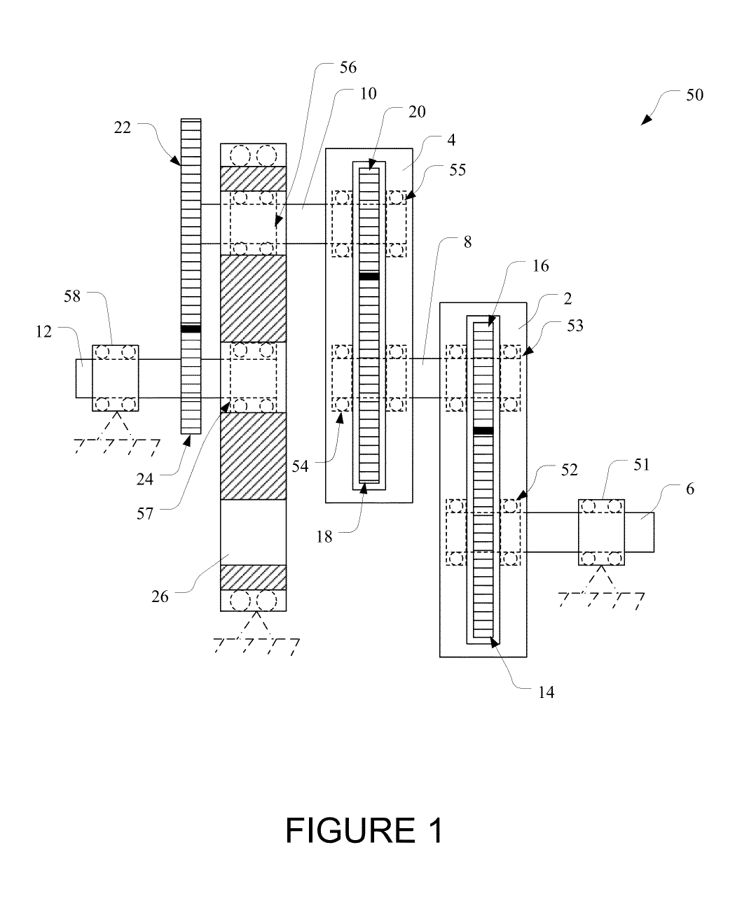

FIG. 1 is an illustration of an exemplary two-speed gear system in accordance with one or more embodiments of the present invention.

As illustrated, two-speed gear system 50 includes input axle 6. In a preferred embodiment, input axle 6 may be substantially fixed in position (i.e. prevented from longitudinal or lateral translation) with a bearing 51 at its proximal end. A power source (not shown) may be coupled to the proximal end of input axle 6 to provide rotational motion along the longitudinal axis of input axle 6. In one or more embodiments, the power source coupled with input axle 6 may include one or more turbines, motors, pedals, wheels, or any other mechanism capable of generating rotational force on input axle 6. The power source coupled with input axle 6 may provide a constant or variable rotational energy. The coupling could be through belts, gears, direct drives, etc.

Input axle 6 is further coupled at its distal end to a first end of first arm 2 through one or more bearings 52. The bearings, i.e. 52, allow input axle 6 to rotate freely along its longitudinal axis. Also, since input axle 6 is fixed in position (i.e. spatial), first arm 2 may also rotate about input axle 6, clockwise or counterclockwise. That is, the centerline of input axle 6 acts as a pivot point for first arm 2.

Input axle 6 is further fixedly coupled at its distal end to an input axle gear 14. Input axle gear 14 is configured to rotate with input axle 6. Input axle gear 14 may be located within first arm 2 or independent of first arm 2. Those of skill in the art would appreciate that input axle gear 14 could be located anywhere on the input axle 6 without deviating from the spirit of the invention.

Input axle gear 14 is coupled to first axle input gear 16. The first axle input gear 16 rotates in the opposite direction form that of input axle gear 14. For instance, if input axle gear is rotating in the clockwise direction, then first axle input gear rotates in the counterclockwise direction. In the disclosed embodiment, the ratio of input axle gear 14 to first axle input gear 16 is greater than 1:1. Of course, the preferred gear ratio would depend on the desired outcome, i.e. output rotational velocity to input rotational velocity.

The first axle input gear 16 is fixedly coupled to first axle 8 at the proximal end of first axle 8 such that rotation of first axle input gear 16 causes first axle 8 to rotate about its longitudinal axis. First axle 8 is further coupled at its proximal end to the opposing (i.e. second) end of first arm 2. The coupling of first axle 8 to first arm 2 is through one or more bearings 53. The bearings, i.e. 53, allow first axle 8 to rotate freely along its longitudinal axis. Also, the second (i.e. opposing) end of first arm 2 is not spatially fixed in position, thus it may freely translate, with all the components coupled to it, along an arc defined with the centerline of input axle 6 as its pivot point. Thus, in the preferred embodiment, first axle 8 is configured to rotate along its longitudinal axis as well as translate to change its position.

First axle 8 is further coupled at its distal end to a first end of second arm 4 through one or more bearings 54. The bearings, i.e. 54, allow first axle 8 to rotate freely along its longitudinal axis. First axle 8 also acts as pivot for rotation of second arm 4.

First axle 8 is further fixedly coupled at its distal end to first axle output gear 18. First axle output gear 18 is configured to rotate with first axle 8. First axle output gear 18 may be located within second arm 4 or independent of second arm 4. Those of skill in the art would appreciate that first axle output gear 18 could be located anywhere on the first axle 8 without deviating from the spirit of the invention.

First axle output gear 18 is coupled to second axle input gear 20. In the disclosed embodiment, the ratio of first axle output gear 18 to second axle input gear 20 is greater than 1:1. Of course, the preferred gear ratio would depend on the desired outcome, i.e. ratio of output rotational velocity to input rotational velocity.

The second axle input gear 20 is fixedly coupled to second axle 10 at the proximal end of second axle 10 such that rotation of second axle input gear 20 causes second axle 10 to rotate about its longitudinal axis. Second axle 10 is further coupled at its proximal end to the opposing (i.e. second) end of second arm 4. The coupling of second axle 10 to second arm 4 is through one or more bearings 55. The bearings, i.e. 55, allow second axle 10 to rotate freely along its longitudinal axis.

Second axle 10 is further coupled at its distal end to one or more bearings 56. Bearing 56 is further located in the inner opening of one-way bearing 26. The bearings, i.e. 54, allow second axle 10 to rotate freely along its longitudinal axis. One-way bearings are well known in the art and any suitable one may be used so long as the inner opening is large enough to allow for translation of bearing 56 along its inner circumference.

Second axle 10 is further fixedly coupled at its distal end to second axle output gear 22. Second axle output gear 22 is configured to rotate with second axle 10. Second axle output gear 22 may be located outside of one-way bearing 26 and preferably at the distal tip of second axle 10. Those of skill in the art would appreciate that second axle output gear 22 could be located anywhere on the second axle 10 without deviating from the spirit of the invention. One-way bearing 26 is preferably spatially fixed in position.

Second axle output gear 22 is coupled to output axle gear 24. In the disclosed embodiment, the ratio of second axle output gear 22 to output axle gear 24 is greater than 1:1. Of course, the preferred gear ratio would depend on the desired outcome, i.e. ratio of output rotational velocity to input rotational velocity.

The output axle gear 24 is fixedly coupled to output axle 12 at the proximal end of output axle 12 such that rotation of output axle gear 24 causes output axle 12 to rotate about its longitudinal axis. Output axle 12 is further coupled at its proximal end (e.g. tip) to bearing 57 located at the center of one-way bearing 26. The bearings, i.e. 57, allow output axle 12 to rotate freely along its longitudinal axis.

Output axle 12 is further coupled at its distal end to bearing 55. The bearings 58 allows output axle 12 to rotate freely along its longitudinal axis. Bearing 58 is spatially fixed in position. Output axle 12 is configured to couple to and to drive an external load (not shown) at its distal end.

In one or more embodiments, two-speed gear system 50 is configured for a low speed operation and a high speed operation. High speed or low speed operation depends on alignment or misalignment of the first axle 8 with the output axle 12, which is in the centerline of the one-way bearing 26. When the first axle 8 is misaligned, the two-speed gear system is in high speed operation and conversely, when aligned, the two speed gear system is in low speed operation. Alignment or misalignment depends on load on the output axle. The high speed operation occurs when there is little or no load at the output axle 12. That is, when the load on output axle 12 is less than a certain threshold, the two-speed gear system 50 operates in a high speed configuration. Conversely, when the load on output axle 12 meets or exceeds the threshold, the two-speed gear system 50 transitions into low speed operation. Thus, switching of speeds is automatic and depends on the load.

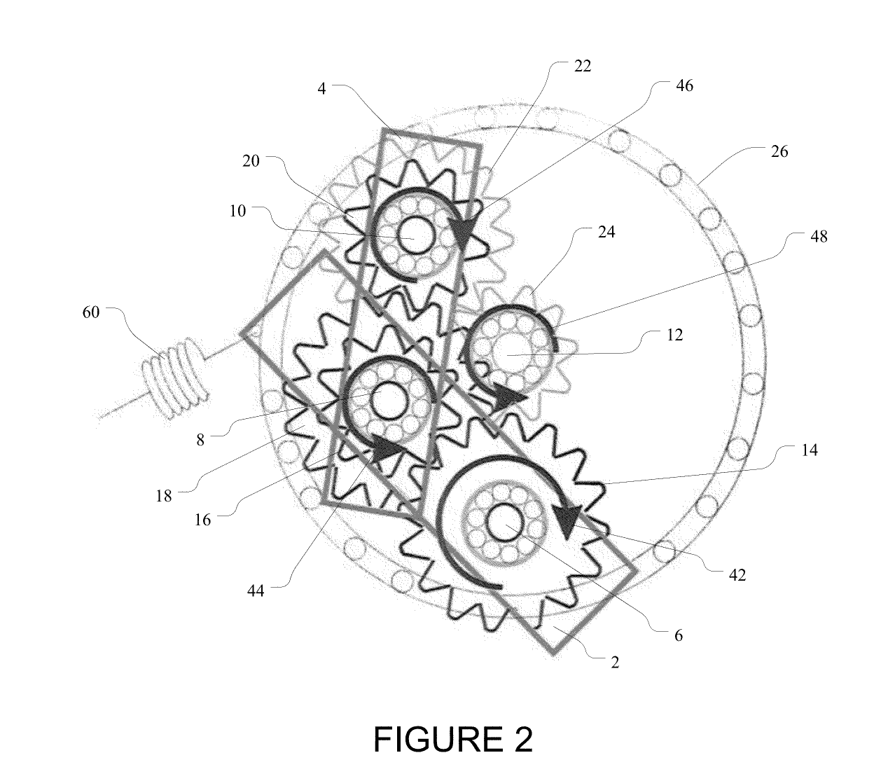

Operation of the two-speed gear system will be described using FIGS. 2, 3, and 4. These figures are illustrations present views from the input axle towards the one-way bearing. Note that these are for illustrative purposes and not meant to be actual drawings of the two-speed gear system.

FIG. 2 is an illustration of the two-speed gear system in a high-speed operation in accordance with one or more embodiments of the present invention. As illustrated, an external power source (not shown) coupled to input axle 6 drives input axle 6 to rotate in rotational direction 42, i.e. clockwise, along its longitudinal axis. The external load (not show) on output axle 12 creates an equivalent force 60 that is less than the predetermined threshold, e.g. no load situation, thus it creates negligible torque, or reaction, back on first arm 2. Therefore, as input axle 6 rotates in clockwise direction 42, first axle 8 rotates counter-clockwise direction 44. The counter-clockwise rotation 44 of first axle 8 creates a momentum that causes first arm 2 to rotate in the counter-clockwise direction. As discussed previously, first arm 2 pivots along input axle 6, thus, the rotation of first arm 2 is around input axle 6 causing the first axle 8 to move in the direction of the left wall (i.e. away from center) of one-way bearing 26 thus resulting in misalignment with the output axle 12, as illustrated in FIG. 2. That is, the longitudinal axis of first axle 8 is translated away from the longitudinal axis of output axis 12. Note that the longitudinal axis of output axle 12 is in the centerline of one-way bearing 26.

In this illustration, rotation of first axle 8 in the counter-clockwise direction causes second arm 4 to rotate in the counter-clockwise direction around its pivot, which is first axle 8. However, as the second axle 10 is confined within the inner circumference of one-way bearing 26 (see FIG. 1), and its pivot (i.e. first axle 8) is off center, the rotation of second arm 4 is inhibited by the one-way bearing 26, as illustrated in FIG. 2. Rotation of second axle 10 causes second axle output gear 22 to rotate along the longitudinal axis of second axle 10, i.e. direction 46 (clockwise), and output axle to rotate in direction 48 (counter-clockwise). At this configuration, the ratio of all the gears sum to produce the rotational velocity of the output axle 12 that is greater than the input rotational velocity at input axle 6. That is, the gears are configured to run in the high speed mode.

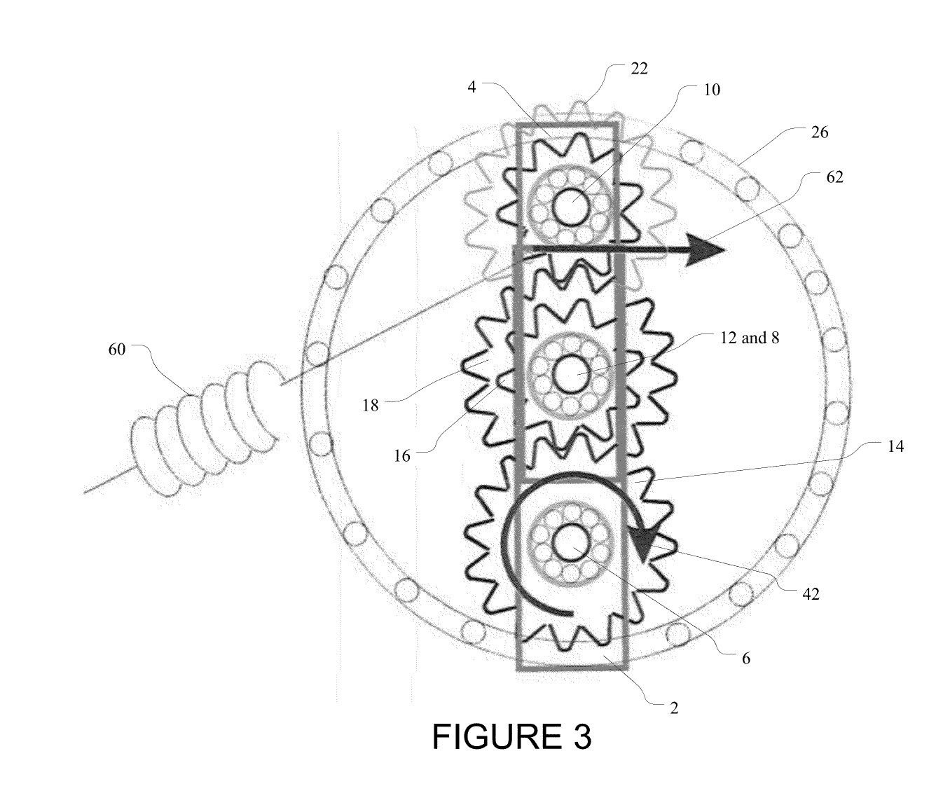

FIG. 3 is an illustration of the two-speed gear system in a transition from high speed to low-speed operation in accordance with one or more embodiments of the present invention. In this illustration, the same external power source (not shown) is coupled to input axle 6 and drives input axle 6 to rotate in rotational direction 42, i.e. clockwise, along its longitudinal axis. The rotational speed of input axle 6 remains the same as in FIG. 2. As the external load on output axle 12 increases, the torque 62 on first arm 2 increases towards the predetermined threshold and the first arm is forced to rotate towards output axle 12. When the torque 62 becomes equal to or greater than the predetermined threshold, first axle 8 is aligned with output axle 12, i.e. the alignment position, as illustrated in FIG. 3. In one or more embodiments, a stopper type device (not shown) may be put in place to limit the rotation of first arm 2 to not exceed the alignment position.

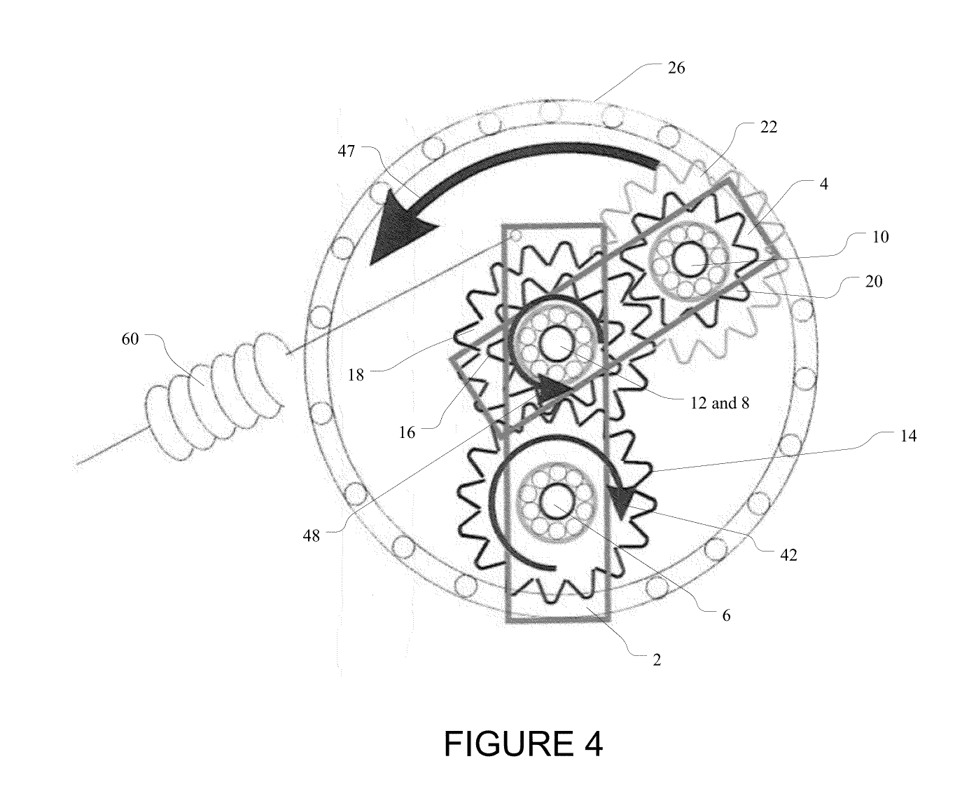

In this configuration, i.e. alignment of first axle 8 with output axle 12, the switching from the high speed mode to the low speed mode is made possible by the one-way bearing 26. In the low speed configuration, the counter-clockwise rotation of first axle 8 causes second arm 4 to rotate in the counter-clockwise direction 40 while pivoted at first axle 8, as illustrated in FIG. 4. Second axle 10 moves around the circumference of the inner opening of one-way bearing 26. Since second arm 4 rotates about the axis of first axle 8, the gearing between the first axle output gear 18 and second axle input gear 20 is irrelevant and the output rotational velocity is affected by the inner diameter of the one-way bearing 26.

FIG. 4 is an illustration of the motion the two-speed gear system in a low-speed configuration in accordance with one or more embodiments of the present invention. As illustrated, when the pivot of second arm 4, i.e. first axle 8, is centered with the longitudinal axis of output axle 12, second arm 4 freely rotates, direction 47, around the inside periphery (i.e. circumference) of one-way bearing 26. In this configuration, the relationship between second axle output gear 22 and output axle gear 24 acts as a reduction because, although second axle output gear 22 rotates with second axle 10, it also rotates within the confines of the inner circumference of one-way bearing 26.

Also, the relationship between first axle output gear 18 and second axle input gear 20 acts as a reduction because, although first axle output gear 18 rotates with first axle 8, it also rotates within the confines of the inner circumference of one-way bearing 26. Thus, the resulting rotational speed transferred from second axle output gear 22 to output axle gear 24 is significantly reduced, e.g. by a factor that has some relationship to the arm distance between the first axle 8 and second axle 10. Thus, when first axle 8 is aligned with output axle 12, the tow-speed gear system 50 operates in a low speed configuration.

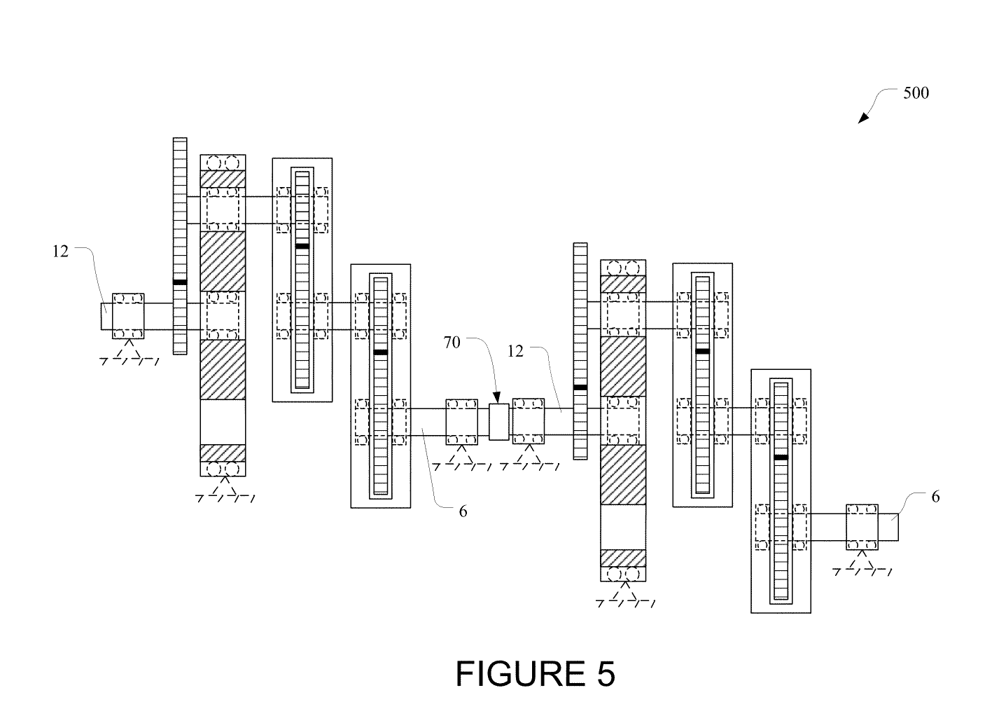

FIG. 5 is an illustration of a cascaded multi-speed gear system in accordance with one or more embodiments of the present invention.

Multiple two-speed gear systems of the present invention may be cascaded to obtain the desired number of speeds. A single two speed gear system is a multi-speed gear system. However, additional speeds may be obtained by cascading more than one two-speed gear system. As illustrated, multi-speed gear system 500 includes two two-speed gear systems coupled together with coupler 70, for example. In this illustration, the output axle of a first two-speed gear system is coupled to the input axle of a second two-speed gear system. Thus, any number of two-speed gear systems may be cascaded in a multi-speed gear system without departing from the spirit or the scope of the invention.

For example, a three-speed gear system can be configured by cascading two two-speed gear systems, a four-speed gear system can be configured by cascading three two-speed gear systems, a five-speed gear system can be configured by cascading four two-speed gear systems, etc.

No hydraulics or electronic controls are necessary to control one or more embodiments of the automatic multi-speed gear system. One or more embodiments of the automatic multi-speed gear system can be used in any application for multi-speed gearing, such as bicycles, electric motors, engines, e.g. motorized vehicles, RC vehicles, motorized toys, startup motors, etc.

Other embodiments of the automatic multi-speed gear system may be directed to multi-speed gear systems with two or more cascaded two-speed gear systems with mechanical control of arm alignment of each two-speed gear system. In one or more embodiments implementing mechanical control of arm alignment for each two-speed gear system, a four-speed gear system can be configured by cascading two two-speed gear systems, an eight-speed gear system can be configured by cascading three two-speed gear systems, a sixteen-speed gear system can be configured by cascading four two-speed gear systems, etc.

While the invention herein disclosed has been described by means of specific embodiments and applications thereof, numerous modifications and variations could be made thereto by those skilled in the art without departing from the scope of the invention set forth in the claims.

What is claimed is:

1. An automatic multi-speed gear system comprising:
at least one gear system, wherein said gear system comprises:
an input axle configured to rotate about its longitudinal axis;
a first arm coupled through a first bearing with said input axle and configured to allow for independent rotational movement of said input axle, wherein a first end of said first arm is coupled to a distal end of said input axle to allow said first arm freedom to rotate about said input axle;
an input axle gear fixedly coupled with said input axle at said distal end of said input axle;
a first axle input gear coupled with said input axle gear, wherein said input axle gear is configured to transfer rotational motion to said first axle input gear;
a first axle fixedly coupled to said first axle input gear at a proximal end of said first axle, wherein said first axle is further coupled to said first arm at a second end of said first arm through a second bearing;
a first axle output gear fixedly coupled with said first axle at a distal end of said first axle;
a second axle input gear coupled with said first axle output gear, wherein said first axle output gear is configured to transfer rotational motion to said second axle input gear;
a second arm coupled through a third bearing with said first axle and configured to allow for independent rotational movement of said first axle, wherein a first end of said second arm is coupled to said distal end of said first axle to allow said second arm freedom to rotate about said first axle;
a second axle fixedly coupled to said second axle input gear at a proximal end of said second axle, wherein said second axle is further coupled to said second arm at a second end of said second arm through a fourth bearing;
a second axle output gear fixedly coupled with said second axle at a distal end of said second axle;
an output axle gear coupled with said second axle output gear, wherein said second axle output gear is configured to transfer rotational motion to said output axle gear;
an output axle fixedly coupled to said output axle gear at a proximal end of said output axle;
a one-way bearing coupling said second axle to said output axle, wherein said second axle is coupled through a fifth bearing in an inside periphery of said one-way bearing, and wherein said output axle is coupled at said proximal end to a sixth bearing to a geometric center of said one-way bearing.

2. The automatic multi-speed gear system of claim 1, wherein said longitudinal axis of said input axle is spatially fixed with a seventh bearing coupled to a proximal end of said input axle.

3. The automatic multi-speed gear system of claim 1, wherein said longitudinal axis of said output axle is spatially fixed with an eight bearing coupled to a distal end of said input axle.

4. The automatic multi-speed gear system of claim 2, wherein said one-way bearing is spatially fixed.

5. The automatic multi-speed gear system of claim 1, wherein said at least one gear system comprises a first gear system and a second gear system, wherein said first gear system and said second gear system are cascaded such that the input axle of said second gear system is the output axle of said first gear system.

6. The automatic multi-speed gear system of claim 1, wherein the input axle is couplable to an external power source.

7. The automatic multi-speed gear system of claim 1, wherein the output axle is couplable to an external load.

8. The automatic multi-speed gear system of claim 7, wherein said gear system operates at a high speed configuration when said external load is below a preset threshold and operates at a low speed configuration when said external load reaches or exceeds said preset threshold.

9. An automatic multi-speed gear system comprising:
at least one gear system, wherein said gear system comprises:
an input axle configured to rotate about its longitudinal axis, wherein said longitudinal axis is spatially fixed;
a first arm coupled through a first bearing with said input axle and configured to allow for independent rotational movement of said input axle, wherein a first end of said first arm is coupled to a distal end of said input axle allowing said first arm to rotate about said input axle;
an input axle gear fixedly coupled with said input axle at said distal end of said input axle;
a first axle input gear coupled with said input axle gear, wherein said input axle gear is configured to transfer rotational motion to said first axle input gear;
a first axle fixedly coupled to said first axle input gear at a proximal end of said first axle, wherein said first axle is further coupled to said first arm at a second end of said first arm through a second bearing;
a first axle output gear fixedly coupled with said first axle at a distal end of said first axle;
a second axle input gear coupled with said first axle output gear, wherein said first axle output gear is configured to transfer rotational motion to said second axle input gear;
a second arm coupled through a third bearing with said first axle and configured to allow for independent rotational movement of said first axle, wherein a first end of said second arm is coupled to said distal end of said first axle allowing said second arm to rotate about said first axle;
a second axle fixedly coupled to said second axle input gear at a proximal end of said second axle, wherein said second axle is further coupled to said second arm at a second end of said second arm through a fourth bearing;
a second axle output gear fixedly coupled with said second axle at a distal end of said second axle;
an output axle gear coupled with said second axle output gear, wherein said second axle output gear is configured to transfer rotational motion to said output axle gear;
an output axle fixedly coupled to said output axle gear at a proximal end of said output axle, wherein said output axle's longitudinal axis is spatially fixed;
a one-way bearing coupling said second axle to said output axle, wherein said second axle is coupled through a fifth bearing in an inside periphery of said one-way bearing, and wherein said output axle is coupled through a sixth bearing to a geometric center of said one-way bearing.

10. The automatic multi-speed gear system of claim 9, wherein said one-way bearing is spatially fixed.

11. The automatic multi-speed gear system of claim 9, wherein said at least one gear system comprises a first gear system and a second gear system, wherein said first gear system and said second gear system are cascaded such that the input axle of said second gear system is the output axle of said first gear system.

12. The automatic multi-speed gear system of claim 9, wherein the input axle is couplable to an external power source.

13. The automatic multi-speed gear system of claim 9, wherein the output axle is couplable to an external load.

14. The automatic multi-speed gear system of claim 13, wherein said gear system operates at a high speed configuration when said external load is below a preset threshold and operates at a low speed configuration when said external load reaches or exceeds said preset threshold.

15. An automatic multi-speed gear system comprising:
at least one gear system, wherein said gear system comprises:
an input axle configured to rotate about its longitudinal axis, wherein said longitudinal axis is spatially fixed;
a first arm coupled with said input axle and configured to allow for independent rotational movement of said input axle, wherein a first end of said first arm is coupled to a distal end of said input axle allowing said first arm to rotate about said input axle;
an input axle gear fixedly coupled with said input axle at said distal end of said input axle;
a first axle input gear coupled with said input axle gear, wherein said input axle gear is configured to transfer rotational motion to said first axle input gear;
a first axle fixedly coupled to said first axle input gear at a proximal end of said first axle, wherein said first axle is further coupled to said first arm at a second end of said first arm;
a first axle output gear fixedly coupled with said first axle at a distal end of said first axle;
a second axle input gear coupled with said first axle output gear, wherein said first axle output gear is configured to transfer rotational motion to said second axle input gear;
a second arm coupled with said first axle and configured to allow for independent rotational movement of said first axle, wherein a first end of said second arm is coupled to said distal end of said first axle such that said second arm can rotate about said first axle;
a second axle fixedly coupled to said second axle input gear at a proximal end of said second axle, wherein said second axle is further coupled to said second arm at a second end of said second arm;
a second axle output gear fixedly coupled with said second axle at a distal end of said second axle;
an output axle gear coupled with said second axle output gear, wherein said second axle output gear is configured to transfer rotational motion to said output axle gear;
an output axle fixedly coupled to said output axle gear at a proximal end of said output axle, wherein said output axle's longitudinal axis is spatially fixed;
a one-way bearing coupling said second axle to said output axle, wherein said second axle is coupled through an inside periphery of said one-way bearing, and wherein said output axle is coupled to a geometric center of said one-way bearing.

16. The automatic multi-speed gear system of claim 15, wherein said one-way bearing is spatially fixed.

17. The automatic multi-speed gear system of claim 15, wherein said at least one gear system comprises a first gear system and a second gear system, wherein said first gear system and said second gear system are cascaded such that the input axle of said second gear system is the output axle of said first gear system.

18. The automatic multi-speed gear system of claim 15, wherein the input axle is couplable to an external power source.

19. The automatic multi-speed gear system of claim 15, wherein the output axle is couplable to an external load.

20. The automatic multi-speed gear system of claim 19, wherein said gear system operates at a high speed configuration when said external load is below a preset threshold and operates at a low speed configuration when said external load reaches or exceeds said preset threshold.
